(19) United States
(12) Patent Application Publication
(10) Pub. No.: US 2004/0078134 A1
(43) Pub. Date: Apr. 22, 2004

(54) Electric fuel control system for motorcycle

(76) Inventors: Mingshan Yin, Chongging City (CN); Xiangdong Zhou, Chongging City (CN)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/469,446

(22) PCT Filed: May 23, 2001
(86) PCT No.: PCT/CN01/00859

(30) Foreign Application Priority Data
Mar. 19, 2001 (CN) 01103877.2

(51) Int. Cl. F02D 41/30; F02D 43/04

(52) U.S. Cl. 701/104; 701/107; 123/406.47

(57) ABSTRACT

The present invention relates to an electric control fuel injection system for motorcycle, especially for middle and small volume motorcycle. The invention includes CMOS chips, sensors, etc. The different air/fuel ratio corresponding to operating conditions can be obtained with the help of programs and parameters stored in the system and instantaneous parameters measured by sensors. The simple structure, less pollution and economy system can accurately control air/fuel ratio and ignition advance angle.

### FIELD OF THE INVENTION

The present invention relates to a fuel control system for engines, especially to an electronic fuel injection system suitable for motorcycle with small or medium displacement.

### BACKGROUND OF THE INVENTION

In prior art, the fuel supply apparatus used in the engines of motors with small or medium displacement are generally carburetors. The function of the carburetors is to atomize the fuel into fine particles, to mix air with the atomized fuel at a suitable ratio (air/fuel ratio) and to supply the engine with a gas mixture with optimum air/fuel ratio.

The change rule of the air/fuel ratio provided by the carburetor in the engine depends on the flow rules of the fuel and air. Because the carburetor provides fuel by vacuum sucking, it is difficult to provide gas mixture in optimum air/fuel ratio and made the gas mixture fully burnt. The engine can not maintain at the best efficiency. In addition, the levels of exhaust emissions from motors and the fuel economy are not satisfactory.

In addition, the throttle of the traditional carburetors controls the amount of fuel by adjusting the jet. Therefore, it can not automatically control the concentration of gas mixture instantaneously according to the changes of the operating conditions and situations of the engine. It also can not control the air/fuel ratio around the theoretical value. By using carburetor to supply fuel, the air/fuel ratio of the gas mixture is either too big or too small.

In order to provide the engine with a gas mixture at an optimum ratio under any operating conditions, and to control the concentration of the gas mixture instantaneously according to the changes of the operating conditions and situations of the engine, a lot of studies have been made. However, there hardly have been successful reports until now. Although some progresses have been achieved in electronic fuel injection technology of engines with big displacement or twin-cylinder and four-stroke, because of its complicated structure and high cost, it is difficult to manufacture industrially. Besides, it is hard to be applied directly to four-stroke and single cylinder motor engines with small or medium displacements.

CN2399520 discloses an electronic fuel injection apparatus for engines. It mainly relates to the circuits and the process of signals. However, it does not disclose the connection modes between the apparatus with the engine and the working procedure.

CN2351577 discloses an electronic fuel injection apparatus for motors. It also does not disclose the connection modes between the apparatus with the engine and the working procedure.

EP0212988 discloses a control apparatus for worm gear pressure-increasing internal combustion engine. It discloses part technologies of electronic fuel injection for engines. However, since the number of the controlling points is relatively less and the locations of the controlling points are not reasonable, it can not realize the “precise control” as mentioned in the present invention.

EP0397521 discloses a circular control system for engines. The electric controlled portion also has defects of less data collecting units and unreasonable location of said units. It also can not realize the “precise control” as mentioned in the present invention.

### OBJECTS OF THE INVENTION

One object of the present invention is to provide an electronic fuel injection system especially suitable for internal combustion engines with small or medium displacement, including four-stroke motors with single cylinder.

The second object of the present invention is to provide an engine using the above-mentioned electronic fuel injection system suitable for motors with small or medium displacement.

The third object of the present inversion is to provide a motor with the above-mentioned engine.

### SUMMARY OF THE INVENTION

The present invention provides a system including an engine, chips, circuits, and sensors. By using the various programs and parameters stored in the chips in combination of the instantaneously parameters of the main parts in the vehicle obtained from the sensors, a precise instantaneously calculation can be realized. The engine of the present invention can control the air/fuel ratio precisely. In addition, the engine mentioned above has the advantages of better ignition advance angle, simple structure, higher automation degree, less amount of exhausting gas and less fuel consumption.

In combination with the accompanying drawings and the preferred examples, the above-mentioned objects, characteristics and advantages will become more apparent in the following description.

### BRIEF DESCRIPTION OF THE DRAWINGS

FIG. 1 shows the connection relationship between the electronic fuel injection system for motors of the present invention with the electric-circuit controlling unit 18, wherein 39 represents an external connection circuit.

FIG. 2 is the front view and partial sectional view of the throttle 6 of FIG. 1.

FIG. 3 is the right view and partial sectional view of FIG. 2.

FIGS. 4(a) and (b) are the circuit block diagram of the 18 in FIG. 1.

FIG. 5 is the controlling flow diagram of the present invention.

### DETAILED DESCRIPTION OF THE INVENTION

The engine of the present invention includes fuel passages, fuel pipes, a fuel pump, a fuel filter, a fuel pressure adjuster, a fuel rail, a throttle body, a sensor for sensing the opening degree of the throttle, an inlet passage, a sensor for sensing the temperature of the cylinder head, an engine, a fly wheel, a sensor for sensing the rotating speed and the ignition signal, and an electronic-driven fuel injector etc.

The throttle body provided in the inlet passage consists of a shell, a throttle, an adjusting wheel for controlling the opening degree of the throttle, a rotating shaft, a back spring, an initial adjusting screw, a fixing spring, a fuel rail, and a connecting mouth of fuel pipe. Wherein, the throttle is mounted in the shell and is fixed on the rotating shaft by screws. The rotating shaft passes through the shaft radically, one end of the shaft is provided with the adjusting wheel, and the other end of the shaft is connected with the sensor for sensing the opening degree of the throttle. The back spring is sleeved on the rotating shaft and is located between the shell and the adjusting wheel. The initial screw is provided on the shell, and the extending end of the screw contacts the rotating wheel. The fuel rail is provided above the shell, and it connects with the shell via an electronic-driven fuel injector. The fuel connection mouth connects with the fuel pipe. A sensor for sensing the temperature of the inlet air is provided at a position ahead of the throttle body.

The electric-circuit controlling unit (it will be referred as ECU hereinafter) consists of a microprocessor and converting circuit 32, a signal processing circuit 33, an ignition circuit 34, a fuel injection circuit 35, a fuel pump control circuit 36, a signal collection circuit 37, a reposition circuit 38, an external connection circuit 39 and a power supply circuit 40. Wherein, the input of the circuit 32 connects with the signal collection circuit 37, the signal processing circuit 33, the reposition circuit 38, and the power supply circuit 40 respectively, and the output of it connects with the circuits the ignition circuit 34, the fuel injection circuit 35, the fuel pump control circuit 36, the reposition circuit 38 and the external connection circuit 39 respectively.

In addition to connect with the circuit 32, the input of the circuit 39 also connects with the circuits 34, 35, 36, and 40 respectively. In addition to connect with the circuits 33, 37 and 40 respectively, the output of the circuit 39 also connects with the fuel pump, the electronic-driven fuel injector, the sensor for sensing the temperature of the inlet air, the sensor for sensing the opening degree of the throttle, the sensor for sensing the temperature of the cylinder head, the sensor for sensing the rotating speed and the ignition signal, and the igniter respectively.

The circuit 32 in the ECU 18 is a storage device containing computer programs. It not only stores the programs for calculating the opening degree of the throttle, the temperature of the cylinder head, the temperature of the inlet air, the rotating speed and the ignition signal, the programs for obtaining time and air/fuel ratio data, and the overall running program, but also stores the following programs:

a. A program for calculating the time of injecting fuel for fuel injector, a program for calculating the opening degree of the throttle, the temperature of the cylinder head, the temperature of inlet air, the rotating speed and the ignition signal, and a program for data analysis and comparison device for comparing the calculated results with the time under various operating modes;

b. A program for the fuel injection apparatus controlled by the signals from the various sensors and the signals from the data analysis and comparison device;

c. A program for a failure storing and displaying device;

d. A program for a fuel-saving and protection device;

e. A program for the ignition device controlled by the output signals from the various sensors and the output signals from the comparison device.

The present invention adopts the ECU and the programs stored in the chips 41, and various running status of the engine are monitored by the various sensors. Based on the signals of the flowing amount of the air detected directly or indirectly, the amount of fuel needed for the combustion in the engine can be calculated precisely by a computer. Then, a starting signal is provided to the fuel injector, and the delaying time is controlled correspondingly. After that, the fuel with a suitable pressure is provided with the engine via the fuel injector. Therefore, the engine can have an optimum air/fuel mixture with suitable air/fuel ratio under various operating modes.

According to the theoretical calculation and experiment results, 14.7 kg air is needed for thoroughly combusting 1 kg gasoline under standard state. However, the air/fuel ratio will be changed according to the different operating modes of the engine in practice.

In order to realize the functions of the system of the present invention as mentioned above, it is necessary to further explain the structure of the engine, the electronic-controlling apparatus, their connection modes and running modes.

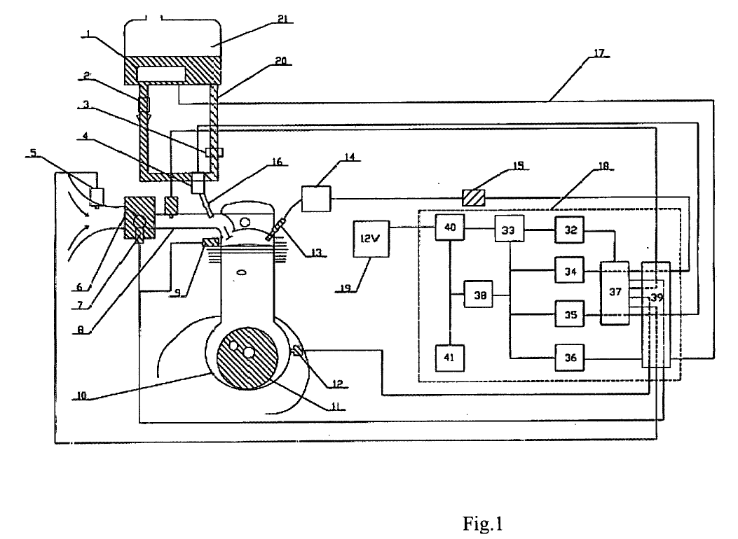

As shown in FIG. 1, the engine includes a fuel pump 1, a fuel filter 2, a fuel pressure adjuster 3, a fuel rail 4, a temperature sensor 5 for inlet air, a throttle body 6, a sensor 7 for controlling the opening degree of the throttle, an inlet air passage 8, a temperature sensor 9 for sensing the temperature of the cylinder head, an engine 10, a fly wheel 11, a sensor 12 for detecting the rotating speed and ignition signal, a spark plug 13, an ignition coil 14, an igniter 15, an electronic-driven fuel injector 16, a wire 17, an ECU 18, an accumulator 19, a fuel pipe 20 and a fuel tank 21.

The connection and location relationship of the various parts as shown in FIG. 1 are as follows:

The fuel pump 1 is disposed in the fuel tank 21. The fuel pipe 20 is provided under the fuel pump 1 and the fuel tank 21. The fuel filter 2 is provided at the outlet of the fuel tank 21. The fuel pressure adjuster 3 is provided at the inlet of the fuel pipe 20. The fuel rail 4 is provided at the middle of the fuel pipe 20. The fuel rail 4 connects with the inlet air passage 8 via the electronic-driven fuel injector 16. The temperature sensor 9 for sensing the cylinder head and the spark plug 13 are provided at the cylinder head of the engine. The spark plug 13 connects with the igniter 15 via the ignition coil 14. The sensor for sensing the rotating speed and ignition signals 12 is provided around the flywheel 11 that locates at the lower portion of the engine 10. The throttle body 6 locates on the inlet air passage 8 of the engine. The temperature sensor 5 for inlet air is provided at the head of the throttle body 6, and the electronic-driven fuel injector 16 is provided behind the throttle body 6. The fuel pump 1, the fuel rail 4, the temperature sensor 5 for inlet air, the sensor 7 for controlling the opening degree of the throttle, the sensor 12 for rotating speed and ignition signal, the igniter 15 and the electronic-driven fuel injector 16 are connected with the ECU 18 via the wire 17 respectively. The ECU 18 is connected with the accumulator 19.

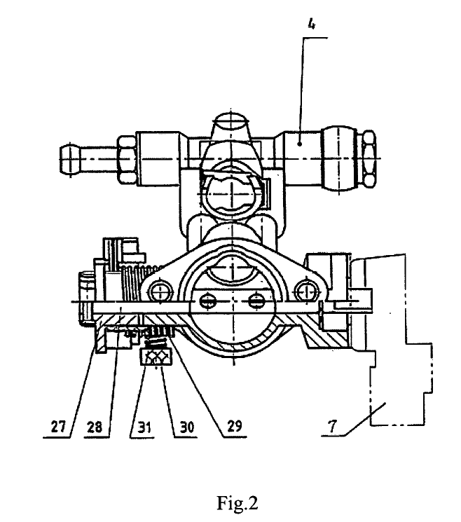

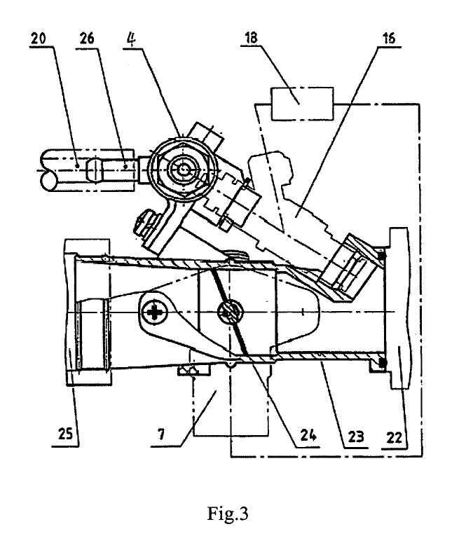

It can be seen further from FIGS. 2 and 3 that, the throttle body 6 mounted on the inlet air passage 8 consists of a shell 23, a throttle 24, an adjusting wheel 27 for adjusting the opening degree of the throttle 24, a rotating shaft 28, a back spring 29, an initial adjusting screw 30, a fixing spring 31, a fuel rail 4, and a connection mouth 26 for the fuel pipe.

Wherein, the throttle 24 is provided in the shell 23 and is fixed on the rotating shaft 28 via screws. The rotating shaft 28 passes through the shell 23 radically. One end of it is provided with the adjusting wheel 27, and the other end of it connects with the sensor 27. The back spring 29 is sleeved on the rotating shaft 28, and is located between the shell 23 and the sensor 27. The initial adjusting screw 30 is provided on the shell 23, and the extending end of the screw 30 contacts the rotating shaft 28. The fuel rail 4 is provided above the shell 23, and is connected with the shell 23 via the electronic-driven fuel injector 16. The connection mouth 26 on the fuel rail 4 connects with the fuel pipe 20.

From FIGS. 1 and 3, it can be seen clearly that the throttle shell body 23 is also the inlet air passage 8. One end of the shell body 23 is connected with the cylinder head 22 of the engine of the vehicle, and the other end is connected with the air cleaner 25 of the engine. The temperature sensor locates both above the shell body 23 and at the middle of the fuel pipe 20. The sensor 7 and the electronic-driven fuel injector 16 connect with the ECU 18 via wires.

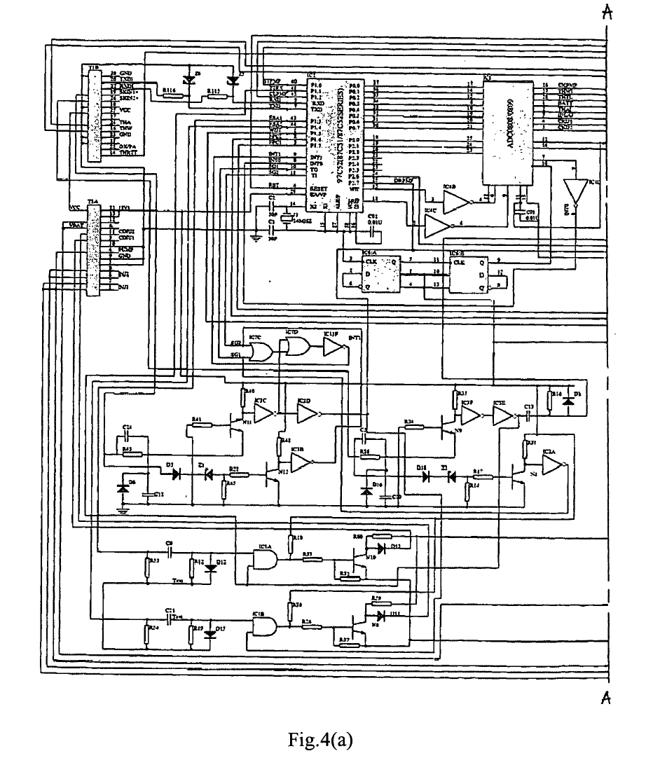

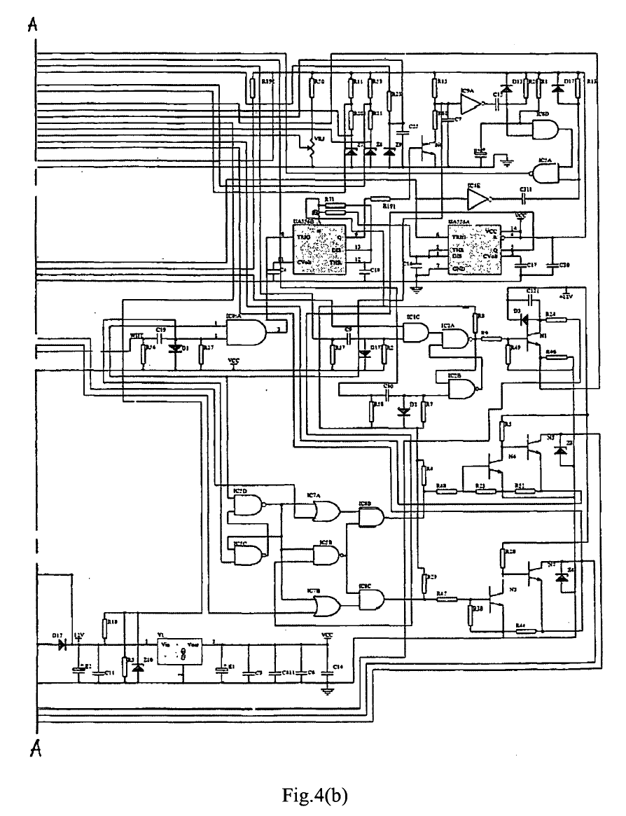

As shown by FIGS. 4(a) and 4(b), the ECU 18 of the present invention is a controlling unit, which includes a microprocessor and converting circuit 32, a signal processing circuit 33, an ignition circuit 34, a fuel injection circuit 35, a fuel pump control circuit 36, a signal collection circuit 37, a reposition circuit 38, an external connection circuit 39 and a power supply circuit 40.

Wherein, the input of the circuit 32 connects with the circuits 37, 33, 38, and 40 respectively, and the output of it connects with the circuits 34, 35, 36, 38, and 39 respectively.

In addition to connect with the circuit 32, the input of the circuit 39 also connects with the circuits 34, 35, 36, and 40 respectively.

In addition to connect with the circuits 33, 37 and 40 respectively, the output of the circuit 39 also connects with the fuel pump 1, the electronic-driven fuel injector 16, the sensor 5 for sensing the temperature of the inlet air, the sensor 7 for sensing the opening degree of the throttle, the sensor 9 for sensing the temperature of the cylinder head, the sensor 12 for sensing the rotating speed and the ignition signal, and the igniter 15 respectively.

The circuit 32 in the ECU 18 is a storage device containing computer programs. It not only stores the programs for calculating the opening degree of the throttle, the temperature of the cylinder head, the temperature of the inlet air, the rotating speed and the ignition signal, the programs for obtaining time and air/fuel ratio data, and the overall running program, but also stores: I. a program for calculating the time of injecting fuel; II. programs for calculating the opening degree of the throttle, the temperature of the cylinder head, the temperature of inlet air, the rotating speed and the ignition signal, and a program for data analysis and comparison device for comparing the calculated results; III. a program for the fuel injection apparatus controlled by the signals from the various sensors and the signals from the data analysis and comparison device; IV. a program for a failure storing and displaying device; V. a program for a fuel-saving and protection device; VI. a program for the ignition device controlled by the output signals from the various sensors and the output signals from the comparison device.

The fuel injection device is operated by the program stored in the circuit 32 shown in FIG. 4(a) according to the following steps:

allocating the results stored in the program for calculating the time of injecting fuel;

terminating the run corresponding to the shutting off signal stored in the overall running program.

The fuel-saving and protection device is operated by the program stored in the circuit 32 shown in FIG. 4(a) according to the following steps:

when the motor is under the state of gear shifting and increasing fuel or running at an accelerating speed, this device does not work;

when the motor is under the state of gear shifting and decreasing fuel or coasting, this device control the fuel injection device to stop the fuel injection.

The failure storage and display device operated by the program stored in the circuit 32 is such a device that when the electronic-controlled fuel injection system of the present invention is failed, a failure code is displayed on the display device according to the type of the failure.

In addition to connect with the circuit 32, the output of signal process circuit 32 of the ECU 18 as shown in FIG. 4(a) and FIG. 4(b) also connects with the circuit 34 and the circuit 38 respectively.

Wherein, in addition to connect with the circuit 32, the input of the electronic-driven fuel injection circuit 35 also connects with the circuit 38. In addition to connect with the circuit 39, the output of it also connects with the circuit 32.

Furthermore, in addition to connect with the circuit 32, the inlet of the fuel pump control circuit 36 also connects with the circuit 33.

The composition and the functions of the various circuit units in the ECU 18 of the present invention are as follows:

1. The Microprocessor and Converting Circuit 32

The microprocessor uses 97C52 (or 87C51/87C52 series) chips, the A/D converter uses ADC0808/0809 chips or other chips having equivalent functions.

The signals collected from the throttle sensor, the cylinder temperature sensor, the inlet air sensor and the rotating speed sensor will be converted by A/D converter firstly. Then these signals will be processed by the microprocessor of this circuit to issue corresponding orders according to the needs under different operating modes to control the working states of the fuel pump, the fuel injector and the igniter. Therefore, the ignition angle and the air/fuel ratio of the gas mixture entering the engine can be at optimum values.

The IC4B, IC4C, IC4D and IC6 are used to exchange the information between the microprocessor and the A/D converter.

2. The Signal Processing Circuit 33

This circuit consists of IC3A, IC3B, IC3C, IC3D, IC3E, IC3F, IC7C, IC7D, IC13F, N2, N9, N11, N12, D5, D6, Z1, D16, D18, Z2, D8, C24, C20, C12, C13, C5, R16, R31, R14, R17, R35, R34, R36, R42, R40, R41, R43, R22 and R45.

The input of this circuit connects with the circuit 39, and the output of the circuit connects with the circuits 32, 34 and 38 respectively. The signals of rotating speed SIGN undergo decoupling, rectifying, amplitude discrimination and power level conversion before they are sent to the microprocessor as the phase reference for the fuel injecting and igniting, and provide interrupt signals to the igniting circuit 34 for the control of ignition as well as to the resetting circuit as controlling signals of the reposition circuit 38.

3. The Ignition Circuit 34

This circuit mainly consists of R54, R19, C21, D15, IC1B, R38, R26, R37, N8, D11, R59, R55, R12, D12, C8, IC1A, R18, R33, R32, N10, R60 and D13.

The input of this circuit connects with the circuits 32 and 33 respectively, and the output of the circuit connects with the circuit 39. The igniting circuit generates and sends igniting pulses to the electronic igniter according to the revolution speed signals and the instruction signal ESA from the microprocessor, so that the electronic igniter generates high voltage pulses to ignite the spark plug.

4. The Electronic-Driven Fuel Injection Circuit 35

This circuit consists of IC5D, IC5C, IC7A, IC5B, IC7B, IC8B, IC8C, R4, R48, R25, N4, R5, N5, Z3, R52, R29, R47, R30, N3, R44, R28, N7 and Z4.

The input of this circuit connects with the circuits 32 and 38 respectively, and the output of it connects with the circuits 32 and 39 respectively.

This circuit includes a logic control circuit and an amplification circuit. The RS trigger consisted of IC5D and IC5D is controlled by the reposition signal and produces a direct positioning signal to control the fuel injection device. IC7A and IC7B will issue a signal for fuel injection pulse to drive the fuel injector according to the position state, the order for fuel injection (FPC) issued by the microprocessor in combination with the state of the microprocessor (issued by IC5B), and this signal is amplified by N4 to drive N5 to obtain a fuel injection pulse, and this pulse will drive the fuel injector to work.

In the drawing, R52 is a sampling resistance used for detection.

When the microprocessor circuit is in failure and can not work normally, IC5B receives a fixed signal issued by UA556 to drive the fuel injector at a fixed frequency and flow amount. In this way, the motor can run temporarily. Thus, this circuit is called as “go home” circuit.

5. The Fuel Pump Control Circuit 36

This circuit consists of R57, C9, D173, R2, R58, C10, D2, R7, IC1C, IC2A, IC2B, R8, R9, R49, N1, R46, D3, R24 and C121.

The input of this circuit connects with the circuits 32 and 33 respectively, and the output of it connects with the circuits 32 and 39 respectively. According to the signals of start or stop issued by the microprocessor and the working signals issued by the circuit 33, which have been processed logically by the IC1C, IC2A and IC2B, this circuit will drive the fuel relay to work.

Wherein, D3 and C121 are protection circuits; R46 is a sampling resistance for failure detection.

The DRPMP signal of IC1C is effective when “going home”.

6. The Signal Collection Circuit 37

This circuit consists of R192, R50, VRJ, R1, R20, Z7, R53, R21, Z8, R23, Z9 and C25.

This circuit delivers the collected signals to the circuit 32. Wherein, the throttle signal THRTT are sampled by R23, Z9 and C25, and are sent to the A/D converter. The cylinder temperature signal THW are sampled by R20, Z7 and are sent to the A/D converter. The air temperature signals THA are sampled by R21, Z8 and are sent to the A/D converter. R50 and VRJ are used to adjust the amount of the injected fuel slightly.

7. The Reposition Circuit 38

This circuit mainly consists of UA556A, UA556B, IC4E, IC5A, IC8D, IC8A, IC9A and related external circuits.

The input of this circuit connects with the circuits 32 and 33 respectively, and the output of the circuit connects with the circuit 35. The program monitoring signal WDT in the microprocessor triggers UA556A and UA556B circuits to issue a reposition signal RST. When the power is connected or the program is in failure, it can make reposition for the microprocessor to make it back to the initial state. Thus, the program can work under normal state.

Another function of the UA556A and UA556B is to issue “go home” signal when the microprocessor stop working because of failure to make the “go home” circuit work.

8. The External Connection Circuit 39

This circuit mainly consists of T1A, T1B, R116, R115, Z6 and Z5.

In addition to connect with the circuit 32, the input of this circuit also connects with the circuits 34, 35, 36 and 40 respectively, and the output of it connects with the circuits 33, 37 and 40 respectively.

The T1A and T1B are core sockets, and they are used to connect with the external power supply, the sensors, the fuel pump relay, the fuel injector, the failure display device and the igniter.

Wherein, INJ connects with the fuel injector. PUMP connects with the fuel pump relay. CDIU connects with the igniter. VCC is the output power of 5 V. SIGN connects with the rotating-speed signal sensor. GND connects with ground. THRTT connects with the throttle sensor. THW connects with the cylinder temperature sensor. THA connects with the inlet air temperature sensor. VBAT connects to a 12V power supply. RXD and TXD connect with the failure display device.

9. The Power Supply Circuit 40

This circuit consists of D17, E1, E2, Z10, R10, R3, C1, C3, C411, C6, C14 and GND.

The input of this circuit connects with the accumulator of motor, and the output of it connects with the power ends of the various circuit units respectively to provide with power to the various circuits.

In this circuit, Z10, R10 and R3 are used to be the detecting power supply, and the detecting results are sent to the microprocessor via the A/D converter.

The working procedures of the electronic-controlled fuel injection system of the present invention are as follows:

When the power is connected, the ECU 18 receives a reposition signal, and a start signal will be sent to the relay of the fuel pump 1 within 6 seconds. The fuel in the fuel tank 21, after pressure adjusting by the fuel pressure adjuster 3, will be delivered into the electronic-driven fuel injector 16.

When the starter button of the engine is pressed, the sensor 7 will have a movement. The movement will produce a weak signal, and this signal will be delivered to the ECU 18. After receiving this signal, the ECU 18 will send a starting signal to the relay of the fuel pump 1 to make it connected to power, and the fuel pump 1 will start to work.

At the time of pressing the starter button, the start motor will drive the crankshaft of the engine to rotate. For each revolution, the sensor 12 will issue an ignition pulse signal to the ECU 18.

At the same time, the sensor 12, the sensor 5 ahead of the throttle body 6 and the sensor 9 will produce electronic signals corresponding to the situations, such as the rotating speed, the inlet air temperature, the cylinder head temperature etc., of the engine at the time of starting, and these signals will be delivered to the ECU 18. These signals are processed by the program stored in 97C52 to obtain an optimum amount of fuel to be injected, and a signal derived from the results are delivered to the output of the electronic-driven fuel injector 16.

The fuel is supplied to the electrical-driven fuel injector 16 via the fuel pipe 20, the fuel pipe connection mouth 26, and the fuel rail 4. According to the fuel injection signal provided by the ECU 18, the fuel is injected by the electronic-driven fuel injector 16.

The fuel is supplied to the electronic-controlled fuel injector 16 via the fuel pipe 20, the connection mouth 26 of the fuel pipe and the fuel tail 4, and then the electronic-controlled fuel injector 16 jets fuel according to the jet signal from the ECU 18

At the time of starting the electronic-driven fuel injector 16, the igniter 15 receives an ignition signal (including that of ignition advance angle) from the ECU 18. An electric spark will be produced by the spark plug 13 via a high-voltage coil and the ignition coil 14, and this spark will ignite the fuel/air gas mixture in the combustion chamber of the engine. Therefore, the engine is started and will begin to work normally.

When the engine runs under the states of accelerating, decelerating or running with load, the various sensors will issue various corresponding signals to the ECU 18. The ECU 18 will calculate the starting time and ignition signal for the electronic-driven fuel injector 16. Therefore, the optimum running data can be obtained for the engine under different operating modes.

The above-mentioned various operating modes, and the adjustment of the starting time, the air/fuel ratio and corresponding ignition angle in accordance with instant operating modes for the electronic-driven fuel injector 16 are well-known by the person skilled in the art.

The control flowchart for the electronic-controlled fuel injection system of the present invention are as follows:

1. Reposition

2. Allocation of the sub-program for measuring the rotation speed

3. Criterion: Whether the rotation speed<the reference value. If the answer is N, continue. If the answer is Y, back to 1.

4. Criterion: rotating speed>=the reference value. If the answer is N, continue. If the answer is Y, back to 1 after the “fuel injection time is cleaned to zero”.

5. Allocation of the sub-program for the opening degree of the throttle

6. Criterion: Whether the throttle is at the idling position. If the answer is Y, continue. If the answer is N, then criterion: “whether the opening degree of the throttle-last opening degree of the throttle>the reference value”.

7. Criterion: Whether the rotating speed>the reference value. If the answer is N, continue. If the answer is Y, back to 1 after the “fuel injection time is cleaned to zero”.

8. Allocation of the sub-program for the stored charts.

9. Allocation of the sub-program for measuring temperatures.

10. Allocation of the sub-program for adjusting the temperatures by the stored charts.

11. Correction of the results from the charts.

12. Check and store the corrected data, back to 1.

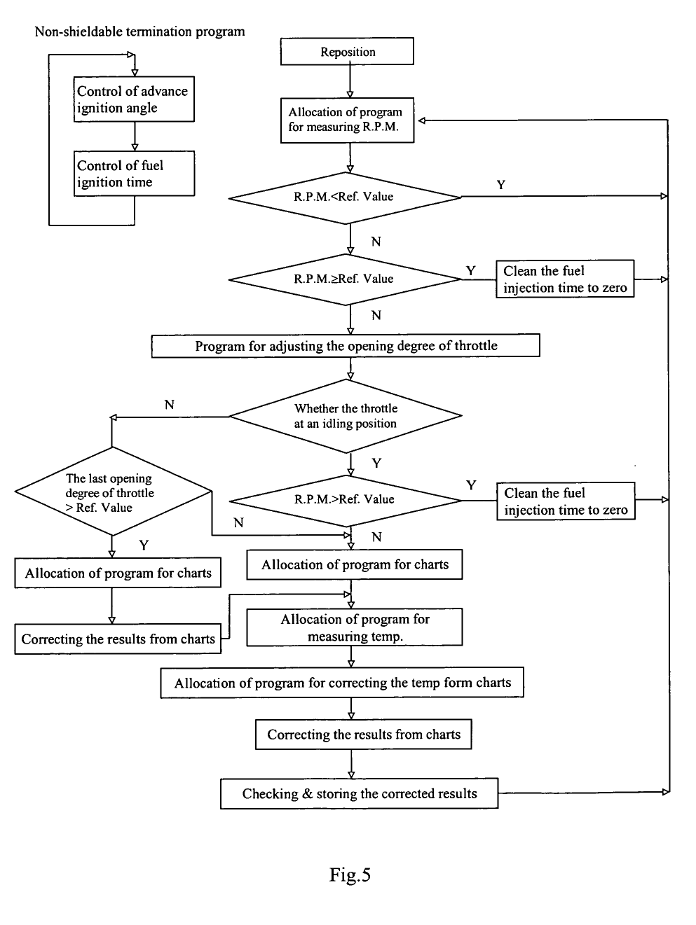

Following the above step 6, if the answer is N, then make a criterion: “whether the opening degree of the throttle−the last opening degree of the restrictor>the reference value”. If the answer is N, back to 8; If the answer is Y, allocate the sub-program for the stored charts, adjust the results from the charts and back to 9, which shown in FIG. 5.

Comparing with the prior art, the electronic-controlled fuel injection system of the present invention has the following advantages:

The electronic-controlled fuel injection system of the present invention can automatically control the concentration of the fuel-air gas mixture instantaneously according to the opening degree of the throttle, the operating modes of the engine and the change of the environment to realize the precise control.

Another advantage of the system of the present invention is that the engine can have a suitable air/fuel ratio under various operating modes.

The system of the present invention also has the advantages of simple structure, higher automation degree, small pollution level and saving fuel. The system of the present invention is suitable for the internal combustion engine with small or medium displacement, especially for the four-stroke engine with small displacement.

Although a certain preferred embodiment has been shown and described, it should be understood that many changes and modifications may be made therein without departing from the scope of the appended claims.

What is claimed is:

1. An electronic-controlled fuel injection system for motors, including a fuel pump, a fuel rail, a temperature sensor for inlet air, a sensor for controlling the opening degree of the throttle, a temperature sensor for sensing the temperature of the cylinder, a sensor for detecting the rotating speed and ignition signal, an igniter, an electronic-driven fuel injector, which are connected with an ECU respectively, the ECU being connected with power via wires; wherein:
said ECU includes a microprocessor and converting circuit (32), a signal processing circuit (33), an ignition circuit (34), a fuel injection circuit (35), a fuel pump control circuit (36), a signal collection circuit (37), a reposition circuit (38), an external connection circuit (39) and a power supply circuit (40);
wherein, the input of the circuit (32) connects with the circuits (37, 33, 38, and 40) respectively, and the output of it connects with the circuits (34, 35, 36, 38, and 39) respectively;
the output of said circuit (33) connects with the circuits (32, 34 and 38) respectively;
the input of the circuit (39) connects with the circuits (34, 35, 36, and 40) respectively; the output of the circuit connects with the circuits (33, 37, 40) and the fuel pump 1, the electronic-driven fuel injector 16, the sensor for sensing the temperature of the inlet air (5), the sensor for sensing the opening degree of the throttle (7), the sensor for sensing the temperature of the cylinder head (9), the sensor for sensing the rotating speed and the ignition signal (12), and the igniter (15) respectively;
the input of the circuit (35) connects with the circuits (32, and 38) respectively; the output of the circuit (35) connects with the circuits (32 and 39) respectively; this circuit makes fuel injection device started according to the records stored in the memory for storing the fuel injection time and calculated results; and makes the fuel injection device stopped corresponding to the orders stored in the memory for the overall running program;
the input of the circuit (36) connects with the circuits (32, and 33) respectively;
when the motor is under the state of adding fuel or accelerating, the fuel-saving and protection device will not work; when the motor is under the state of decreasing fuel or coasting, this device will control the fuel injection device to stop injecting fuel.

2. The system according to claim 1, characterized in that the signals collected by the sensors are converted by the A/D converter firstly, and various orders are issued by the microprocessor based on the converted signals according to the practical needs under various operating modes to control the states of the fuel pump, fuel injector, the igniter and to make the air/fuel ratio at an optimum value.

3. The system according to claim 1, characterized in that the input of the circuit (33) connects with the circuit (39); and the output of the circuit (33) connects with the circuits (32, 34 and 38) respectively; The signals of rotating speed SIGN undergo decoupling, rectifying, amplitude discrimination and power level conversion before they are sent to the microprocessor as the phase reference for the fuel injecting and igniting, and provide interrupt signals to the igniting circuit (34) for the control of ignition as well as to the resetting circuit as controlling signals of the reposition circuit (38).

4. The system according to claim 1, characterized in that the input of the circuit (34) connects with the circuits (32 and 33); and the output of the circuit (34) connects with the circuit (39); the order signal ESA issued by the microprocessor and the rotating signal together act on this circuit to issue an ignition pulse to the electronic igniter to produce a high voltage pulse to ignite the spark plug.

5. The system according to claim 1, characterized in that the input of the circuit (35) connects with the circuits (32 and 38) respectively; and the output of the circuit (35) connects with the circuits (32, and 39) respectively; this circuit consists of a logic circuit and an amplification circuit; the RS trigger consisted of IC5D and IC5C is controlled by the reposition signal and produces a direct positioning signal to control the fuel injection device; IC7A and IC7B will issue a signal for fuel injection pulse to drive the fuel injector according to the position state, the order for fuel injection (FPC) issued by the microprocessor in combination with the state of the microprocessor (issued by IC5B), and this signal is amplified by N4 to drive N5 to obtain a fuel injection pulse, and this pulse will drive the fuel injector to work.

6. The system according to claim 1, characterized in that when the circuit of the microprocessor is in failure and can not work normally, IC5B receives a fixed signal issued by UA556 to drive the fuel injector at a fixed frequency and flow amount to make the motor work temporarily.

7. The system according to claim 1, characterized in that the input of the circuit (36) connects with the circuits (32) and (33) respectively; and the output of it connects with the circuits (32) and (39) respectively; according to the signals of start or stop issued by the microprocessor and the working signals issued by the circuit (33), which have been processed logically by the IC1C, IC2A and IC2B, this circuit will drive the fuel relay to work.

8. The system according to claim 1, characterized in that the circuit (37) delivers the collected signals to the circuit (32), wherein, the throttle signal THRTT are sampled by R23, Z9 and C25, and are sent to the A/D converter, the cylinder temperature signal THW are sampled by R20, Z7 and are sent to the A/D converter; the air temperature signals THA are sampled by R21, Z8 and are sent to the A/D converter; R50 and VRJ are used to adjust the amount of the injected fuel slightly.

9. The system according to claim 1, characterized in that the input of the circuit (38) connects with the circuits (32 and 33) respectively, and the output of the circuit connects with the circuit (35); the program—monitored signal WDT in the microprocessor triggers UA556A and UA556B circuits to make this circuit to issue a reposition signal RST; when the power is connected or the program is in failure, it can make reposition for the microprocessor to make it back to the initial state and to work under normal state.

10. The system according to claim 1, characterized in that the input of the circuit (39) connects with the circuits (32, 34, 35, 36 and 40) respectively, and the output of the circuit (39) connects with the circuits (33, 37 and 40) respectively; wherein, INJ connects with the fuel injector; PUMP connects with the fuel pump relay; CDIU connects with the igniter; VCC is the output power of 5 V; SIGN connects with the rotating-speed signal sensor; GND connects with ground; THRTT connects with the throttle sensor; THW connects with the cylinder temperature sensor; THA connects with the inlet air temperature sensor; VBAT connects to a 12V power supply; RXD and TXD connect with the failure display device.

11. The system according to claim 1, characterized in that the circuit (32) also includes a display device for storing failure data and failure display.

12. An engine installed with an electronic-controlled fuel injection system suitable for motors, wherein, the engine include a fuel tank (21), a fuel pump (1) is disposed in the fuel tank (21), a fuel pipe (20) is provided under the fuel pump (1) and the fuel tank (21), a fuel filter (2) is provided at the outlet of the fuel tank (21), a fuel pressure adjuster (3) is provided at the inlet of the fuel pipe (20), a fuel rail (4) is provided at the middle of the fuel pipe (20), the fuel rail (4) connects with an inlet air passage (8) via an electronic-driven fuel injector (16), a temperature sensor of the cylinder head (9) and a spark plug (13) are provided at the cylinder head of the engine, the spark plug (13) connects with an igniter (15) via an ignition coil (14), a rotating-speed and ignition signal sensor (12) is provided around a fly wheel (11) which locates at the lower portion of the motor (10), a throttle body 6 is located on the inlet air passage (8) of the engine, a temperature sensor (5) for inlet air is provided at the head of the throttle body (6), and the electronic-driven fuel injector (16) is provided behind the throttle body (6); the fuel pump (1), the fuel rail (4), the temperature sensor (5) for inlet air, a sensor (7) for controlling the opening degree of the throttle, a sensor (12) for rotating-speed and ignition signal, the igniter (15) and the electronic-driven fuel injector (16) are connected with the ECU (18) via wire (17) respectively, and the ECU (18) is connected with an accumulator (19);
wherein, the throttle body (6) consists of a shell (23), a throttle (24), an adjusting wheel (27) for adjusting the opening degree, a rotating shaft (28), a back spring (29), an initial adjusting screw (30), a fixing spring (31), a fuel rail (4), and a connection mouth (26) for the fuel pipe.

13. The engine according to claim 12, characterized in that the throttle (24) is provided in the shell (23) and is fixed on the rotating shaft (28) via screws, the rotating shaft (28) passes through the shell (23) radically, one end of the shaft is provided with the adjusting wheel (27), and the other end of the shaft connects with the sensor (7), the back spring (29) is sleeved on the rotating shaft (28), and is located between the shell (23) and the adjusting wheel (27), the initial adjusting screw (30) is provided on the shell, and the extending end of the screw (30) contacts the rotating shaft (28), the fuel rail (4) is provided above the shell (23), and is connected with the shell (23) via the electronic-driven fuel injector (16), the connection mouth (26) on the fuel rail (4) connects with the fuel pipe (20);
one end of the shell body (23) is connected with the cylinder head (22) of the engine of the vehicle, and the other end is connected with the air cleaner (25), the temperature sensor (5) locates both above the shell body (23) and at the middle of the fuel pipe (20), the sensor (7) and the electronic-driven fuel injector (16) connects with the ECU 18 via wires.

14. A motor installed with an electronic-controlled fuel injection system, characterized in that the motor is consisted of a motor body, an engine and a power supply, when the power supply is connected, the ECU (18) receives a reposition signal, and a start signal will be sent to the relay of the fuel pump (1) within 6 seconds, the fuel in the fuel tank (21), after pressure-adjusting by the fuel pressure adjuster (3), will be delivered into the electronic-driven fuel injector (16);
when the starter button of the engine is pressed, the sensor (7) will have a movement, the movement will produce a weak signal, and this signal will be delivered to the ECU (18); after receiving this signal, the ECU (18) will send a starting signal to the relay of the fuel pump (1) to make it connected to power, and the fuel pump (1) will start to work;
at the time of pressing the starter button, the start motor will drive the crankshaft of the engine to rotate; for each revolution, the sensor (12) will issue an ignition pulse signal to the ECU (18);
at the same time, the sensor (12), the sensor (5) and the sensor (9) will produce electronic signals corresponding to the various operating modes of the engine at the time of starting, and these signals will be delivered to the ECU (18), these signals are processed by the program stored in 97C52 to obtain an optimum amount of fuel to be injected, and a signal derived from the results are delivered to the output of the electronic-driven fuel injector (16);
the fuel is supplied to the electronic-driven fuel injector (16) via the fuel pipe (20), the fuel pipe connection mouth (26), and the fuel rail (4); according to the fuel injection signal provided by the ECU (18), the fuel is injected by the electronic-driven fuel injector (16);
at the time of starting the electronic-driven fuel injector (16), the igniter (15) receives an ignition signal (including the signal of ignition advance angle) from the ECU (18); an electric spark will be produced by the spark plug (13) via a high-voltage coil and the ignition coil (14), and this spark will ignite the fuel/air gas mixture in the combustion chamber of the engine; the engine is started and begins to work normally;
when the engine runs under the state of accelerating, decelerating or running with load, the various sensors will issue various corresponding signals to the ECU (18); the ECU (18) will calculate the starting time for the electronic-driven fuel injector (16) and corresponding ignition signal; and an optimum running condition can be obtained for the engine under different operating modes.

15. The motor according to claim 14, characterized in that the calculation programs stored in the ECU (18) include the following:
(1) Reposition;
(2) Allocation of the sub-program for measuring the rotation speed;
(3) Criterion: Whether the rotation speed<the reference value. If the answer is N, continue. If the answer is Y, back to 1;
(4) Criterion: rotating speed>=the reference value. If the answer is N, continue. If the answer is Y, back to 1 after the “fuel injection time is cleaned to zero”;
(5) Allocation of the sub-program for the opening degree of the throttle;
(6) Criterion: Whether the throttle is at the idling position. If the answer is Y, continue. If the answer is N, then criterion: “whether the opening degree of the throttle-last opening degree of the throttle>the reference value”;
(7) Criterion: Whether the rotating speed>the reference value. If the answer is N, continue. If the answer is Y, back to 1 after the “fuel injection time is cleaned to zero”;
(8) Allocation of the sub-program for the stored charts;
(9) Allocation of the sub-program for measuring temperatures;
(10) Allocation of the sub-program for adjusting the temperatures by the stored charts;
(11) Correction of the results from the charts;
(12) Check and store the corrected data, back to (1);
following the above (6), if the answer is N, then make a criterion: “whether the opening degree of the throttle-last opening degree of the throttle>the reference value”; if the answer is N, back to (8); if the answer is Y, allocate the sub-program for the stored charts, adjust the results from the charts and back to (9).
